(19) United States
(12) Patent Application Publication
(10) Pub. No.: US 2005/0027974 A1
(43) Pub. Date: Feb. 3, 2005

(54) Method and system for conserving resources in an instruction pipeline

(76) Inventor: Oded Lempel, Moshav Amikam (IL)

Correspondence Address: KENYON & KENYON, 1500 K STREET, N.W., SUITE 700, WASHINGTON, DC, 20005, US

(21) Appl. No.: 10/630,686

(22) Filed: Jul. 31, 2003

(51) Int. Cl. G06F 9/00

(52) U.S. Cl. 712/239

(57) ABSTRACT

Embodiments of the present invention provide a method, apparatus and system for conserving resources such as power resources in processor instruction pipelines. A branch prediction unit may predict whether a branch is to be taken and an instruction fetch unit may fetch a next sequential instruction. A control circuit may be coupled to the branch prediction unit. The control circuit may abort the next sequential instruction if the branch is predicted to be taken.

### TECHNICAL FIELD

The present invention relates to processors. More particularly, the present invention relates to conserving resources in an instruction pipeline.

### BACKGROUND OF THE INVENTION

Many processors, such as a microprocessor found in a computer, use an instruction pipeline to speed the processing of instructions. Pipelined machines fetch the next instruction before they have completely executed the previous instruction. If the previous instruction was a branch instruction, then the next-instruction fetch could have been from the wrong place. Branch prediction is a known technique employed by a branch prediction unit (BPU) that attempts to infer the proper next instruction address to be fetched. The BPU may predict taken branches and corresponding targets, and may redirect an instruction fetch unit (IFU) to a new instruction stream.

In some cases, the branch prediction mechanism may take more than one cycle to complete. For example, in some processors the prediction may take 2 or more clock cycles to complete. If a taken branch is predicted and/or the predicted target is the highest priority input for the next instruction's linear address, then the IFU may be redirected to the predicted target address. When the BPU redirects the IFU to a new instruction stream and assuming that the prediction takes n>1 cycles, then the fetches by the IFU in the previous n-1 cycles may become irrelevant. These (n-1) fetches occurred while the machine assumed there was no predicted taken branch n cycles ago, and this assumption was proven wrong once the BPU signaled a prediction. The multi-cycle latency on BPU predictions can result in one or more of the instruction fetches to be irrelevant.

Since the fetches in the previous n-1 cycles are determined to be irrelevant, it is desirable to minimize power consumption and/or further processing with respect to the previous instruction fetches. Since power dissipation by BPUs and/or IFUs can be an important design consideration, it is desirable to shut down all irrelevant circuitry and/or processes to conserve power.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of a system in accordance with an embodiment of the present invention;

FIG. 2 illustrates a detailed block diagram of a branch prediction unit and an instruction fetch unit in accordance with an embodiment of the present invention;

FIG. 3 is a table in accordance with an exemplary embodiment of the present invention;

FIG. 4 illustrates an exemplary control circuit in accordance with an embodiment of the present invention; and

FIG. 5 is a flow chart illustrating a method in accordance with an embodiment of the present invention.

### DETAILED DESCRIPTION

Embodiments of the present invention provide a method and apparatus for conserving resources such as power resources in processor instruction pipelines. For example, embodiments of the present invention may turn off circuitry that may be processing irrelevant instructions when it is determined, for example, that a branch is predicted to be taken.

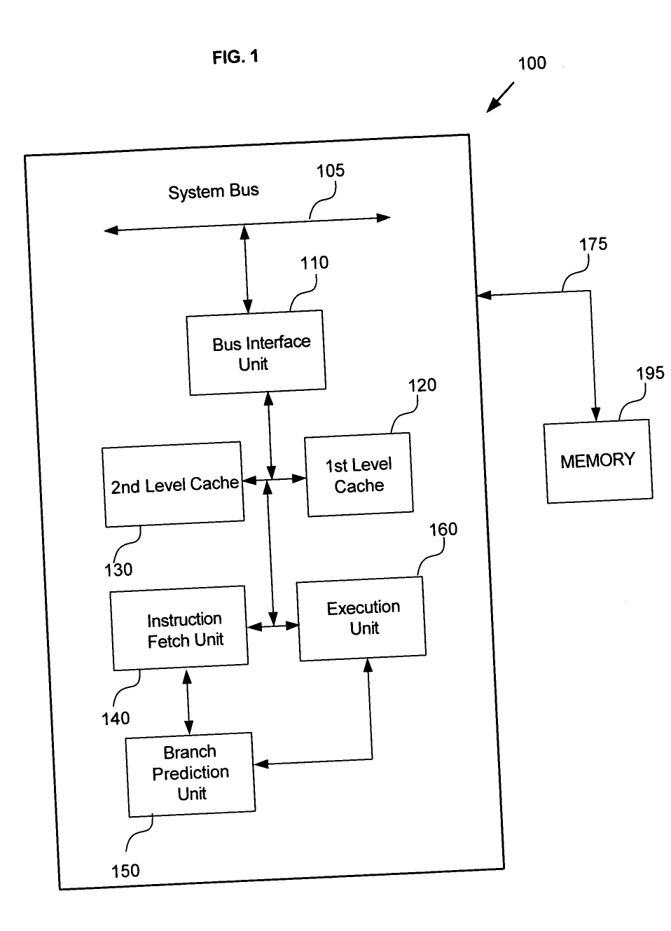

FIG. 1 is a simplified block diagram of a system including a portion of a processor 100 in which embodiments of the present invention may find application. As shown in FIG. 1, a bus interface unit (BIU) 110 may be coupled to a system bus 105. The BIU 110 may be coupled to 1^{st} level cache (L1 cache) 120 and/or to 2^{nd} level cache (L2 cache) 130. The L1 cache 120 may include L1 data cache as well as L1 instruction cache. It is recognized that, in some cases, L1 data cache may be split from the L1 instruction cache. The L2 cache 130 may interface with the instruction fetch unit (IFU) pipeline 140 which may interface with the execution unit 160 and the branch prediction unit (BPU) pipeline 150. It is recognized that the BIU 110 may interface with the IFU 140. The execution unit 160 may interface with the L1 cache 120 as shown.

It should be recognized that the block configuration shown in FIG. 1 and the corresponding description is given by way of example only and for the purpose of explanation in reference to the present invention. It is recognized that the processor 100 may be configured in different ways and/or may include other components.

In embodiments of the present invention, the processor 100 may communicate with other components such as an external memory 195 via an external bus 175. The external memory may be any type of memory such as static random access memory (SRAM), dynamic random access memory (DRAM), read only memory (ROM), XDR DRAM, Rambus® DRAM (RDRAM) manufactured by Rambus, Inc. (Rambus is a registered trademark of Rambus, Inc. of Los Altos, Calif.), double data rate (DDR) memory modules), AGP and/or any other type of memory. The external bus 175 and/or system bus 105 may be a peripheral component interconnect (PCI) bus (PCI Special Interest Group (SIG) PCI Specification, Revision 2.1, Jun. 1, 1995), industry standard architecture (ISA) bus, or any other type of local bus. It is recognized that the processor 100 may communicate with other components or devices.

As is known, information may enter the processor 100 via the system bus 105 through the BIU 110. The information may be sent to the L2 cache 130 and/or the L1 cache 120. Information may also be sent to L1 instruction cache that may be included in the IFU 140. The BIU 110 may send the program code or instructions to the L1 instruction cache and may send data to be used by the code to the L1 data cache. The IFU 140 may pull instructions from the L1 instruction cache that may be located internal to the IFU 140. The IFU 140 may fetch and/or process instructions to be executed by the execution unit 160.

The BPU 150 may predict, based on past experiences, heuristics and/or other algorithms such as indications from the IFU 140, whether a branch of an instruction should be taken. As is well known, branching occurs where the program's execution may follow one of two or more paths. The BPU 150 may direct the IFU 140 to fetch an instruction to be decoded based on a prediction that the branch should be taken. If the prediction is wrong, the IFU pipeline 140 as well as execution unit pipeline 160 may be flushed.

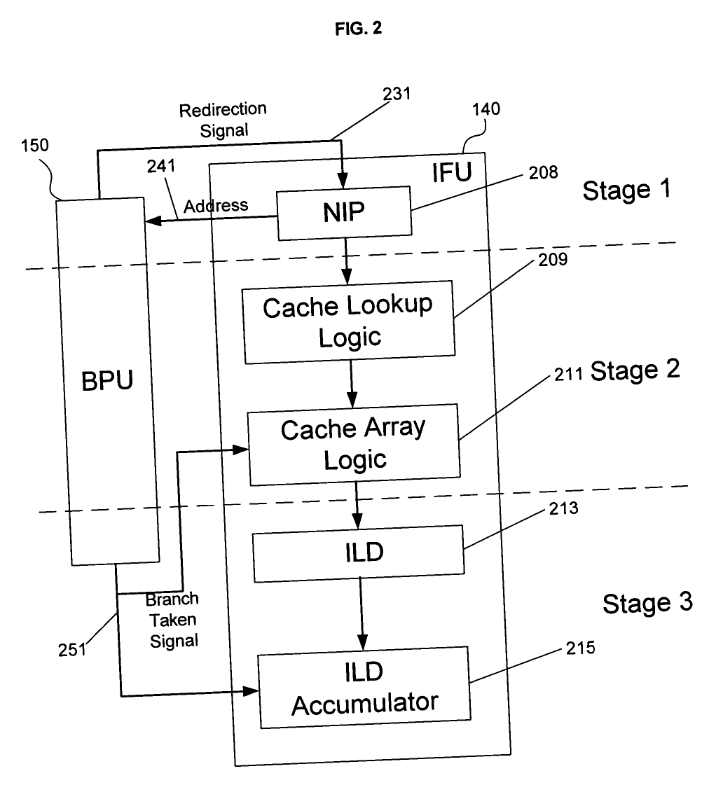

FIG. 2 is a more detailed block diagram of an embodiment of the present invention. The BPU pipeline 150 may be coupled to the IFU pipeline 140, as shown. The IFU 140 may include an instruction fetch next instruction pointer (NIP) 208, cache look up logic 209, cache array logic 211, instruction length decoder (ILD) 213, and an ILD accumulator device 215.

As described above, instruction pipelines may be used to speed the processing of instructions in a processor. Pipelined machines may fetch the next instruction before a previous instruction has been fully executed. In this case, the BPU pipeline 150 may predict that an instruction branch should be taken, and the BPU 150 may redirect IFU 140 to the new instruction stream. Because a branch prediction technique may take more than one cycle (e.g., 2 cycles) to complete, the IFU pipeline 140 may have already started processing information related to the next sequential instruction. As indicated, the next sequential instruction or the next instruction pointer may be determined before the branch prediction is taken. Thus, the IFU pipeline 140 may contain information such as one or more instructions that may now be irrelevant or redundant since they were fetched before the BPU 150 signaled the prediction that the branch would be taken. Embodiments of the present invention may prevent resources from being allocated for processing unnecessary instructions as soon as possible such as when a branch is predicted to be taken. As a result, power consumption of the processor may be reduced. Embodiments of the present invention may block data from entering other pipeline stages earlier than it should for functional correctness. In one embodiment, the data may be blocked or an instruction aborted at a pre-decoding stage such as before reaching the ILD 213.

In accordance with embodiments of the invention, a control circuit may be used to minimize power consumption as soon as the BPU 150 signals the prediction. Thus, processing of the irrelevant instructions can be aborted to conserve resources such as power resources based on, for example, the amount of time (e.g., clock cycles) the BPU takes to make a prediction.

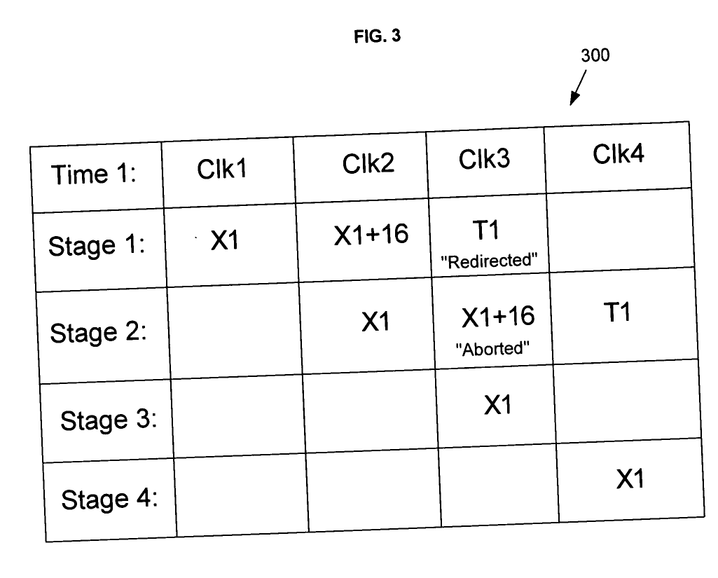

FIG. 3 shows a table 300 illustrating how instructions may be processed through pipeline stages in accordance with embodiments of the present invention. For example, in stage 1 at clock cycle 1 (CLK1), an instruction X1 may be fetched by NIP 208 for processing through the IFU 140 pipeline. The IFU 140 may send the address 241 to the BPU 150, as shown in FIG. 2. At CLK2, the NIP 208 may fetch the next sequential instruction such as X1+16 for processing. The BPU 150 may predict that a branch that has been reached should be taken and the BPU 150 at stage 1, CLK3 may re-direct the NIP 208 to fetch the branch target T1. As shown in FIG. 2, the BPU 150 may send a re-direction signal 231 to the IFU 140 to re-direct it.

In embodiments of the present invention, as a result of the branch, stage 2 of the IFU 140 may contain instruction X1+16 that was fetched by the NIP 208 before the BPU 150 determined that the branch should be taken. Since the branch is predicted to be taken, the instruction X1+16 may now be irrelevant or redundant. In embodiments of the present invention, the BPU 150 may send a branch taken signal 251 to the cache logic array 211 located within IFU 140. Based on the received branch taken signal 251, the IFU 140 may terminate further processing of irrelevant instructions.

In embodiments of the present invention, a control circuit located internal and/or external to the IFU 140 may terminate or abort further processing of information associated with the irrelevant instruction X1+16 at stage 2 of the IFU pipeline 140. Thus, the control circuit may prevent the data from being sent to, for example, ILD 213, saving resources such as power resources, in accordance with embodiments of the present invention. It is recognized that the control circuit may prevent the data from being sent to any other stage so as to conserve resources such as power resources. As shown in table 300, the instruction X1+16 may be aborted at stage 2, CLK3, when the BPU 150 predicted that the branch is to be taken. The IFU pipeline 140 may continue to process other instructions such as instructions X1, T1, etc. Embodiments of the present invention may block data from any other source pipeline stage to any other destination stage.

If the BPU 150 predicts that the branch is not to be taken, the IFU 140 may continue to process the instruction X1+16. Information related to instruction may be processed in the cache logic array 211 and the processed information may be forwarded to the ILD 213 that may further forward the related information to the ILD accumulator 215.

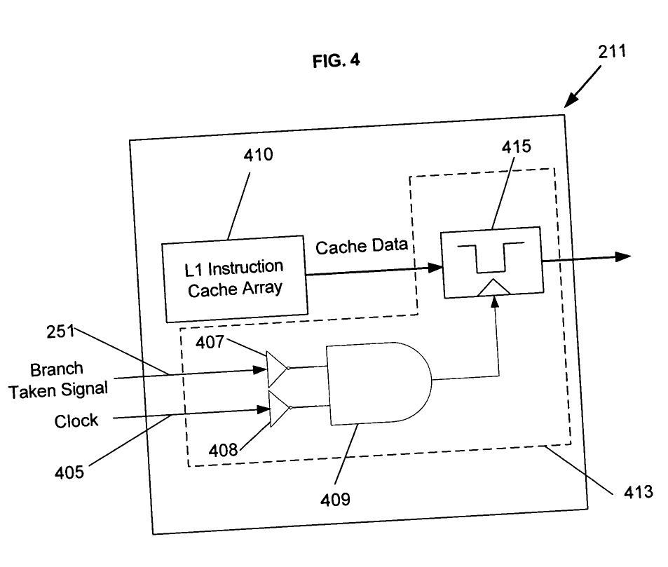

FIG. 4 shows an example of cache array logic 211 that may be included in IFU 140, in accordance with embodiments of the present invention. As shown in FIG. 4, the cache array logic 211 may include an L1 instruction cache array 410 and control circuitry 413 that may include inverters 407, 408, AND gate 409, and/or a sequential element such as a latch 415. The control circuitry 413 may be used to control the output of the cache array 410, included in the cache array logic 211, to the ILD 213. The cache array 410 may include instructions that may be output to the ILD 213 for processing.

In embodiments of the present invention, a branch taken signal 251 may be input to the AND gate 409 via inverter 407. The inverted signal 251 may be ANDed with an inverted clock signal 405 and the output may be used to control latch 415. In one example, if the BPU 150 determines that a predicted branch is taken, the BPU 150 may output a logical “1” as the prediction taken signal 251. However, the inverter 407 inverts this input to a “0” which may be ANDed with the clock signal 405. The output of the AND gate 409, which in this case may be a “0,” may be used to turn the latch 415 to the “off” state and prevent the irrelevant instruction (e.g., X1+16) from being output to the ILD 213. Accordingly, the ILD 213 may not receive the irrelevant or redundant instructions for processing. As a result, resources such as power resources may be conserved, in accordance with embodiments of the present invention. Since power dissipation by BPUs and/or IFUs can be an important design consideration, it is desirable to shut down all irrelevant circuitry and/or processes to conserve power.

It is recognized that the control circuit 413 described above is given by way of example only and the control circuit may be configured in many other ways. It is further recognized that the control circuit 413 and/or any portion thereof may be located external to the cache array logic 211 and/or IFU 140, for example.

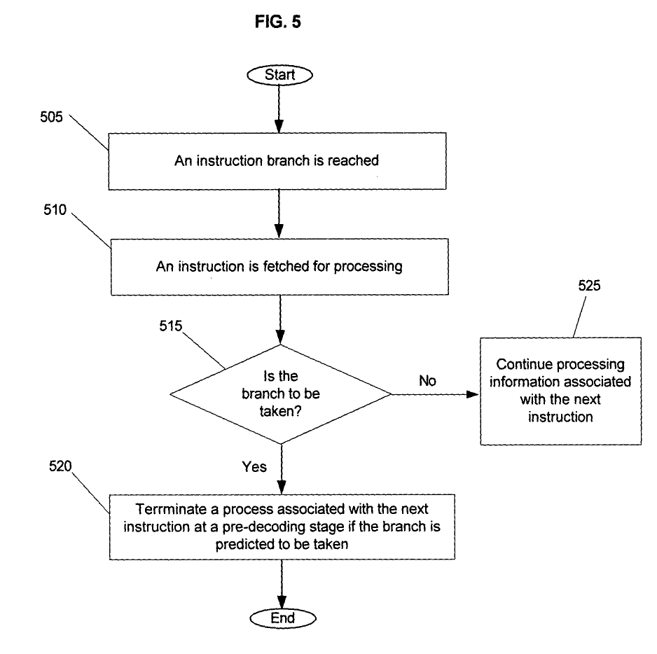

FIG. 5 is a flowchart illustrating a method in accordance with an embodiment of the present invention. A branch instruction may be reached in a BPU 150, as shown in box 505. The IFU 140, for example, may continue to process the next sequential instruction. The IFU 140 may fetch the next sequential instruction, as shown in box 510. If the branch is predicted to be taken, the process associated with the next sequential instruction may be terminated at a pre-decoding stage, as shown in boxes 515-520. If the branch is not predicted to be taken, the processing related with the next instruction may continue, as shown in 515 and 525.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. Apparatus comprising:
a branch prediction unit to predict whether a branch is to be taken;
an instruction fetch unit to fetch an instruction; and
a control circuit coupled to the branch prediction unit, wherein the control circuit is to abort the fetched instruction at a pre-decoding stage if the branch is predicted to be taken.

2. The apparatus of claim 1, further comprising:
an instruction length decoder, wherein the control circuit is to block data associated with the instruction from entering the instruction length decoder.

3. The apparatus of claim 1, further comprising:
an instruction length decoder, wherein the control circuit is to block processing of data associated with the instruction by the instruction length decoder.

4. The apparatus of claim 1, wherein the instruction fetch unit is to fetch a branch target if the branch prediction unit determines that the branch is predicted to be taken.

5. The apparatus of claim 1, wherein the branch prediction unit is to transmit a branch taken signal to the control circuit if the branch is predicted to be taken.

6. The apparatus of claim 5, wherein the power control circuit is to prevent an output of a cache array to be input to an instruction length decoder in response to the branch taken signal.

7. The apparatus of claim 1, wherein the instruction is a next sequential instruction.

8. A method comprising:
predicting whether a branch is to be taken;
fetching a next instruction;
terminating a process associated with the next sequential instruction if the branch is predicted to be taken.

9. The method of claim 8, further comprising:
blocking data associated with the next sequential instruction from entering an instruction length decoder if the branch is predicted to be taken.

10. The method of claim 8, further comprising:
redirecting an instruction fetch unit to the predicted branch if the branch is predicted to be taken.

11. The method of claim 10, further comprising:
fetching a branch target by the instruction fetch unit if the branch is predicted to be taken.

12. The method of claim 8, further comprising:
transmitting a branch taken signal to a control circuit if the branch is predicted to be taken.

13. The method of claim 12, further comprising:
terminating power for processes associated with the next sequential instruction if the branch signal is received.

14. An apparatus comprising:
means for predicting whether a branch is to be taken;
means for fetching a next sequential instruction; and
means coupled to the branch prediction unit for aborting the next sequential instruction if the branch is predicted to be taken.

15. The apparatus of claim 14, comprises:
means for preventing information associated with the next sequential instruction from being sent to an instruction length decoder if the branch is predicted to be taken.

16. A system comprising:
a bus;
an external memory coupled to the bus; and
a processor coupled to the bus, the processor including:
a branch prediction unit to predict whether a branch is to be taken;
a instruction fetch unit to fetch a next sequential instruction; and
a control circuit coupled to the branch prediction unit, the control circuit to abort the next sequential instruction if the branch is predicted to be taken.

17. The system of claim 16, wherein the bus is a PCI bus.

18. The system of claim 16, wherein the bus is an ISA bus.

19. The system of claim 16, wherein the external memory is a SRAM.

20. The system of claim 16, wherein the external memory is a DRAM.

21. The system of claim 16, the processor further including:
an instruction length decoder, wherein the control circuit is to block data associated with the next instruction from entering the instruction length decoder.

22. The system of claim 16, the processor further including:
an instruction length decoder, wherein the control circuit is to block processing of data associated with the next instruction by the instruction length decoder.

23. The system of claim 16, wherein the instruction fetch unit is to fetch a branch target if the branch prediction unit determines that the branch is predicted to be taken.

24. The system of claim 16, wherein the branch prediction unit is to transmit a branch taken signal to the control circuit if the branch is predicted to be taken.

25. The system of claim 24, wherein the power control circuit is to prevent an output of a cache array to be input to an instruction length decoder in response to the branch taken signal.

26. The system of claim 16, wherein the next instruction is a next sequential instruction.

27. Apparatus comprising:
an instruction pointer to fetch a next sequential instruction for processing;
an instruction cache array coupled to the instruction pointer to output information associated with the next sequential instruction;
a latch coupled between the output of the instruction cache array and a instruction length decoder;
a circuit to open the latch if a branch taken signal is received, wherein the branch taken signal indicates that a branch has been predicted to be taken.

28. The apparatus of claim 27, the circuit comprising:
an AND gate having a first input, second input and an output, wherein the first input is an inverted branch taken signal and the second input is an inverted clock and the output is used to open the latch to prevent the information associated with the next sequential instruction from being output to the instruction length decoder if the branch is predicted to be taken.

29. An apparatus comprising:
an instruction pointer to fetch a next sequential instruction for processing;
a branch prediction unit to determine that a branch is to be taken and generate a branch taken signal;
a cache logic array coupled to the instruction pointer to receive data associated with the next sequential instruction and to receive the branch taken signal;
an instruction length decoder coupled to the cache logic array, wherein responsive to the received branch taken signal, the cache logic array is to abort further processing of the data associated with the next sequential instruction.

30. The apparatus of claim 29, further comprising:
circuitry to block the data associated with the next sequential instruction from entering the instruction length decoder if the branch taken signal is received.
